(19) United States
(12) Patent Application Publication
(10) Pub. No.: US 2020/0333471 A1
(43) Pub. Date: Oct. 22, 2020

(54) ANTENNA STRUCTURE AND WIRELESS COMMUNICATION DEVICE USING THE SAME

(71) Applicant: AMBIT MICROSYSTEMS (SHANGHAI) LTD., Shanghai (CN)

(72) Inventors: YI-HAO CHANG, New Taipei (TW); PO-CHI WANG, New Taipei (TW)

(21) Appl. No.: 16/387,150

(22) Filed: Apr. 17, 2019

(51) Int. Cl. G01S 19/35; H01Q 1/24; H01Q 3/34; H01Q 15/24

(52) U.S. Cl. CPC G01S 19/35; H01Q 15/24; H01Q 3/34; H01Q 1/242

(57) ABSTRACT

An antenna structure providing an improved GPS communication includes a substrate having a first surface and a second surface opposite to the first surface, a first antenna attached to the first surface, and a second antenna attached to the second surface. The first antenna and the second antenna generate waves of equal but opposite amplitude and linear orthogonal polarization thereby forming an antenna with circular polarity.

### FIELD

The subject matter herein generally relates to antennas.

### BACKGROUND

Although a typical GPS patch antenna can meet the needs of users in receiving satellite signal, it is large in size and high in cost, and is not easy to be integrated into small and medium-sized products.

Therefore, there is room for improvement within the art.

### BRIEF DESCRIPTION OF THE DRAWINGS

Implementations of the present disclosure will now be described, by way of embodiment, with reference to the attached figures.

FIG. 1 is an isometric view of an embodiment of an antenna structure used in a wireless communication device.

FIG. 2 is a rear view of the antenna structure of FIG. 1.

FIG. 3 is a front view of the antenna structure of FIG. 1.

FIG. 4 is an axial ratio graph of the antenna structure shown in FIG. 1.

FIG. 5 is a scattering parameter graph of the antenna structure shown in

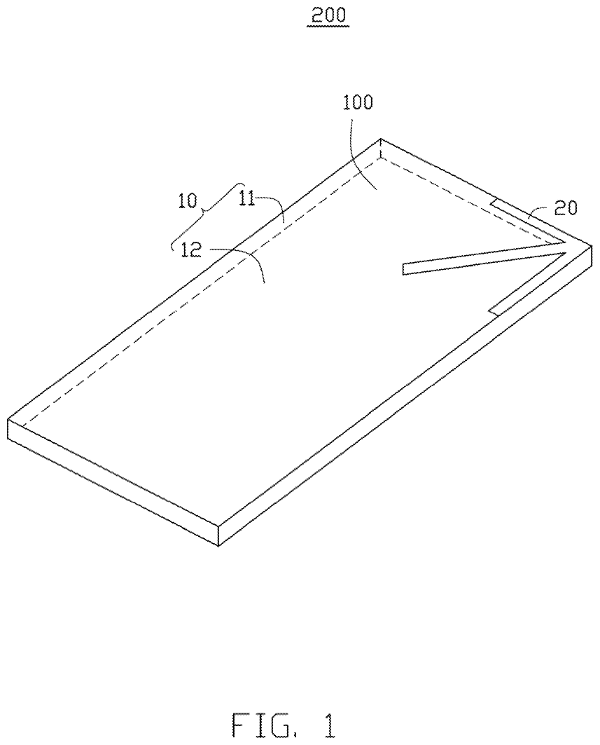

FIG. 1.

FIG. 6 is a schematic diagram of a clockwise polarization of the antenna structure of FIG. 1.

FIG. 7 is a schematic diagram of a counterclockwise polarization of an antenna structure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series, and the like.

The present disclosure is described in relation to an antenna structure and a wireless communication device using the same.

FIG. 1 illustrates an embodiment of antenna structure 100 used in a wireless communication device 200. The antenna structure 100 is configured for receiving and transmitting wireless signals. The wireless communication device 200 can be, for example, a mobile phone, a personal digital assistant. The electronic device 200 also includes other structures and components, which are not described in the present disclosure.

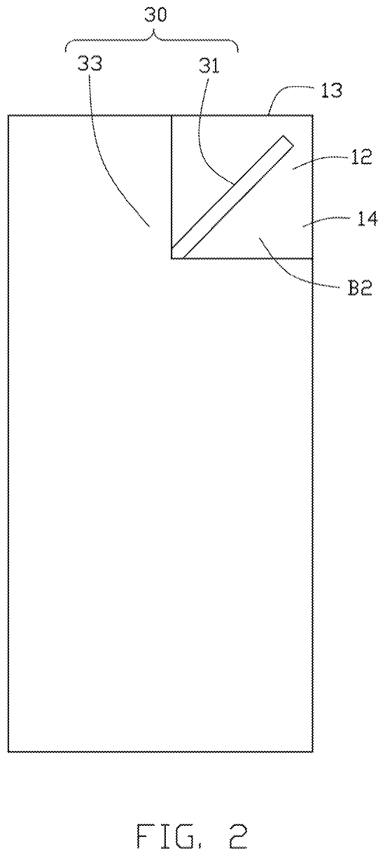

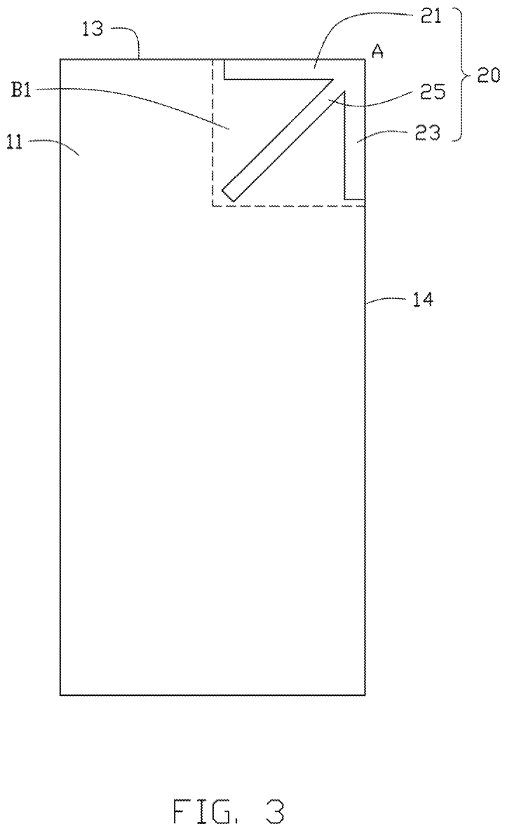

Referring to FIG. 2 and FIG. 3 together, the antenna structure 100 includes a substrate 10, a first antenna 20, and a second antenna 30. In an embodiment, the antenna structure 100 is a global positioning system (GPS) antenna and can operate in a frequency band of about 1575 MHz-1620 MHz.

The substrate 10 can be a printed circuit board (PCB) positioned in the electronic device 200. The substrate 10 includes a first surface 11 and a second surface 12 opposite the first surface 11. The first antenna 20 and the second antenna 30 are respectively attached to the first surface 11 and the second surface 12. Projections of the first antenna 20 and the second antenna 30 on the substrate 10 are coincident. The first antenna 20 and the second antenna 30 can generate waves of opposite but equal amplitude and of linear orthogonal polarization thereby forming an antenna radiating waves in a circular polarization. In this embodiment, a difference between amplitudes and phase angles of electric fields of the first antenna 20 and the second antenna 30 are 180°.

The substrate 10 further includes two parallel and opposite end portions 13 and two parallel and opposite side portions 14. The end portions 13 are perpendicularly connected to ends of side portions 14, to form a substantially rectangular substrate 10.

Referring to FIG. 3 again, in this embodiment, the first antenna 20 includes a first antenna portion 21, a second antenna portion 23, and a feeding portion 25. The first antenna portion 21 and the second antenna portion 23 have the same structure and are substantially strip-shaped. In this embodiment, the first antenna portion 21 and the second antenna portion 23 are both monopole antennas. The first antenna portion 21 is positioned along one of the end portions 13. The second antenna portion 23 is positioned along one of the side portions 14. The first antenna portion 21 and the second antenna portion 23 are perpendicularly connected at angle A of the substrate 10. The feeding portion 25 is substantially strip-shaped. One end of the feeding portion 25 is connected to the angle A, the other end of the feeding portion 25 extends so as to bisect the angle A (that is, the feeding portion 25 meets the first antenna portion 21 and the second antenna portion 23 at about 45°). The first antenna portion 21, the second antenna portion 23, and the feeding portion 25 form a substantially rectangular first antenna region B1 on the first surface 11.

Referring to FIG. 2 again, the second antenna 30 includes a third antenna portion 31 and a grounding portion 33. The third antenna portion 31 is substantially strip-shaped. A structure of the antenna portion 31 is substantially the same as that of the feeding portion 25, the third antenna portion 31 is positioned on the substrate 10 to correspond to the feeding portion 25. Projections of the third antenna portion 31 and the feeding portion 25 on the substrate 10 are substantially coincident. The third antenna portion 31 forms a substantially rectangular second antenna region B2 corresponding to the first antenna region B1 on the second surface 12. One end of the third antenna portion 31 is connected to an angle of the second antenna region B2. The other end of the third antenna portion 31 extends so as to bisect the angle of the second antenna region B2. The second antenna region B2 is substantially coincident with the first antenna region B1. A remaining area of the second surface 12 forms the grounding portion 33.

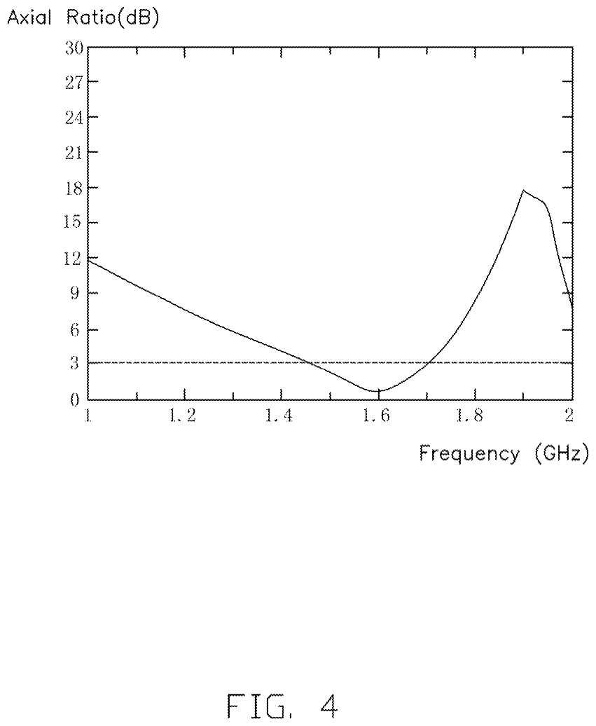

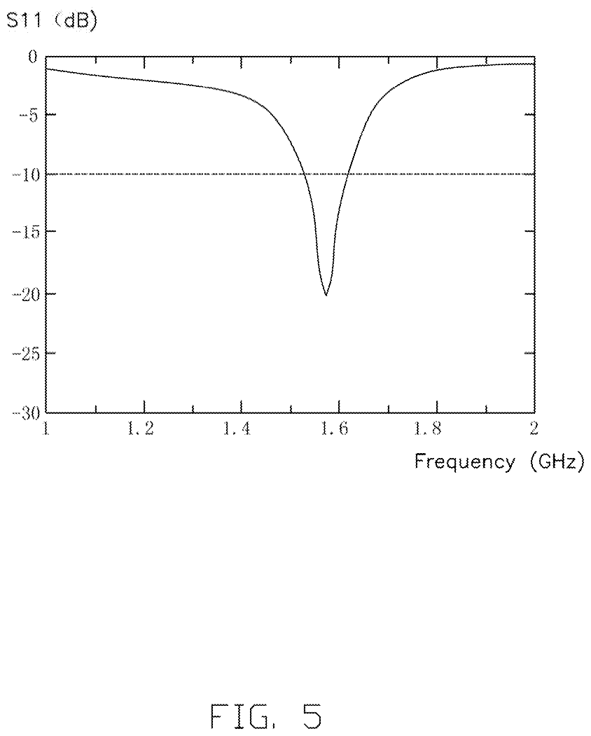

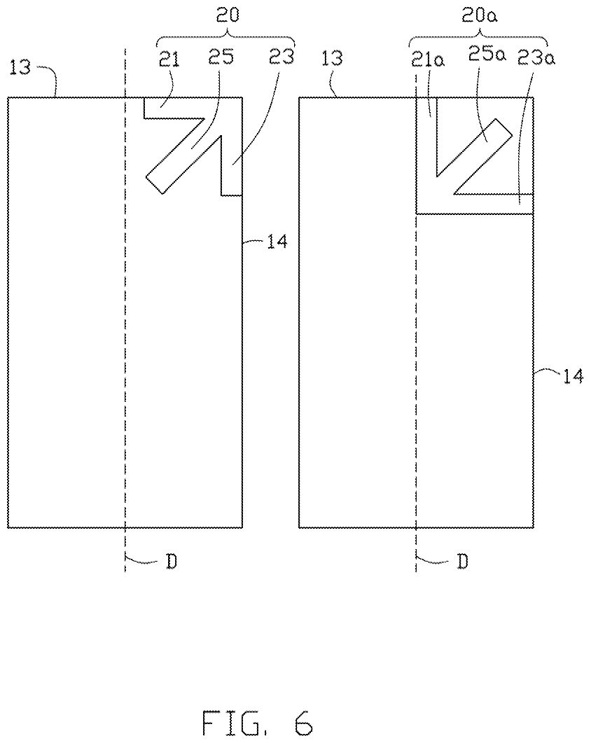

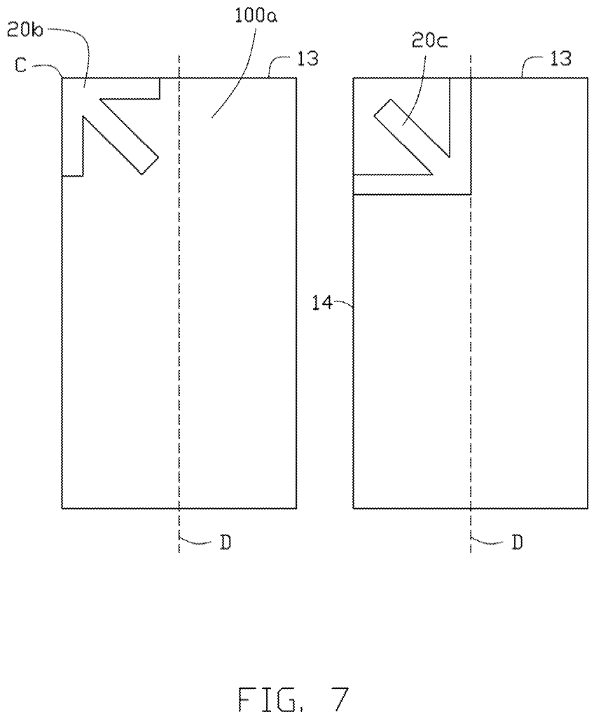

FIG. 4 is an axial ratio graph of the antenna structure 100 of FIG. 1. As test results show (in FIG. 4), a frequency band of the antenna structure 100 having an axial ratio of less than 3 dB can achieve 180 MHz. FIG. 5 shows a scattering parameter graph of the antenna structure 100. As test results show (in FIG. 5), a frequency band of the antenna structure 100 having an S-parameter of less than −10 dB can achieve 110 MHz. Comparing the antenna structure 100 with a typical patch circularly polarized antenna, the antenna structure 100 has a wider axial ratio and a wider bandwidth. This reduces any characteristic shift caused by the environment, thereby obtaining a stable antenna radiation performance. Meanwhile, the antenna structure 100 is directly formed on the substrate 10. In comparison with the typical patch circularly polarized antenna, the antenna structure 100 has advantages of small size, low cost, and easy integration into small devices.

Referring to FIG. 6, the first antenna 20 can be right-hand (clockwise) polarity to form a first antenna 20a. The first antenna 20a includes a first antenna portion 21a, a second antenna portion 23a, and a feeding portion 25a. An end of the first antenna portion 21a is perpendicularly connected to one of the end portion 13. The other end of the first antenna portion 21a extends along a direction parallel to the first side portions 14. An end of the second antenna portion 23a is perpendicularly connected to one of the side portions 14. The other end of the second antenna portion 23a extends along a direction parallel to the end portions 14 and is perpendicularly connected to the first antenna portion 21a to form an angle. In this embodiment, the angle between the first antenna portion 21a and the second antenna portion 23a is 90°. The feeding portion 25a is positioned between the first antenna portion 21a and the second antenna portion 23a. An end of the feeding portion 25a is connected to the angle between the first antenna portion 21a and the second antenna portion 23. The other end of the feeding portion 25a extends so as to bisect the angle.

Referring to FIG. 7, a structure of an antenna structure 100a (a second embodiment) is substantially the same as that of the antenna structure 100. A difference between the antenna structure 100a and the antenna structure 100 is that the antenna structure 100a includes a first antenna 20b. The first antenna 20b is positioned at angle C of the substrate 10 and is symmetrical with the first antenna 20 relative to a central axis D of the substrate 10. The first antenna 20b can be left-handed (counterclockwise) polarity to form a first antenna 20c. The first antenna 20c is symmetrical with the first antenna 20a relative to the central axis D of the substrate 10.

For satellites located in different orientations, for example, in the northern hemisphere or in the southern hemisphere, the antenna structures 100, 100a achieve a better reception and radiation by circular polarizations to the left and to the right.

The embodiments shown and described above are only examples. Many details are often found in the art such as the other features of the antenna structure and the wireless communication device. Therefore, many such details are neither shown nor described. Even though numerous characteristics and advantages of the present disclosure have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna structure comprising:
a substrate comprising a first surface and a second surface opposite to the first surface;
a first antenna attached to the first surface; and
a second antenna attached to the second surface, wherein the first antenna and the second antenna generate waves of opposite but equal amplitude and of linear orthogonal polarization thereby forming an antenna radiating waves in a circular polarization.

2. The antenna structure of claim 1, wherein a difference between amplitudes and phase angles of electric fields of the first antenna and the second antenna are 180°.

3. The antenna structure of claim 1, wherein the substrate further comprises two parallel and opposite end portions and two parallel and opposite side portions, the end portions are perpendicularly connected to ends of side portions, the first antenna comprises a first antenna portion, a second antenna portion, and a feeding portion, the first antenna portion is positioned along one of the end portions, the second antenna portion is positioned along one of the side portions, the first antenna portion and the second antenna portion are perpendicularly connected at an angle of the substrate, an end of the feeding portion is connected to the angle, the other end of the feeding portion extends so as to bisector the angle.

4. The antenna structure of claim 3, wherein the second antenna comprises a third antenna portion and a grounding portion, a structure of the antenna portion is substantially the same as the feeding portion and positioned on the substrate corresponding to the feeding portion, projections of the third antenna portion and the feeding portion on the substrate are substantially coincident, the first antenna forms a first antenna region, the third antenna portion forms a substantially rectangular second antenna region corresponding to the first antenna region on the second surface, an end of the third antenna portion is connected to an angle of the second antenna region, the other end of the third antenna portion extends so as to bisector the angle of the second antenna region, the second antenna region is substantially coincided coincident with the first antenna region, a remaining area of the second surface forms the grounding portion.

5. The antenna structure of claim 1, wherein the substrate further comprises two parallel and opposite end portions and two parallel and opposite side portions, the end portions are perpendicularly connected to both ends of each side portion, the first antenna comprises a first antenna portion, a second antenna portion, and a feeding portion, an end of the first antenna portion is perpendicularly connected to one of the end portion, the other end of the first antenna portion extends along a direction parallel to the first side portions, an end of the second antenna portion is perpendicularly connected to one of the side portions, the other end of the second antenna portion extends along a direction parallel to the end portions and is perpendicularly connected to the first antenna portion to form an angle, an end of the feeding portion is connected to the angle between the first antenna portion and the second antenna portion, the other end of the feeding portion extends so as to bisector the angle.

6. The antenna structure of claim 3, wherein an angle between the feeding portion and one of the first antenna portion and the second antenna portion is 45°.

7. The antenna structure of claim 1, wherein the antenna structure is a global position system antenna and operates in an frequency band of about 1575 MHz-1620 MHz.

8. A wireless communication device comprising:
an antenna structure comprising:
a substrate comprising a first surface and a second surface opposite to the first surface;
a first antenna attached to the first surface; and
a second antenna attached to the second surface, wherein the first antenna and the second antenna generate waves of opposite but equal amplitude and of linear orthogonal polarization thereby forming an antenna radiating waves in a circular polarization.

9. The wireless communication device of claim 8, wherein a difference between amplitudes and phase angles of electric fields of the first antenna and the second antenna are 180°.

10. The wireless communication device of claim 8, wherein the substrate further comprises two parallel and opposite end portions and two parallel and opposite side portions, the end portions are perpendicularly connected to ends of side portions, the first antenna comprises a first antenna portion, a second antenna portion, and a feeding portion, the first antenna portion is positioned along one of the end portions, the second antenna portion is positioned along one of the side portions, the first antenna portion and the second antenna portion are perpendicularly connected at an angle of the substrate, an end of the feeding portion is connected to the angle, the other end of the feeding portion extends so as to bisector the angle.

11. The wireless communication device of claim 10, wherein the second antenna comprises a third antenna portion and a grounding portion, a structure of the antenna portion is substantially the same as the feeding portion and positioned on the substrate corresponding to the feeding portion, projections of the third antenna portion and the feeding portion on the substrate are substantially coincident, the first antenna forms a first antenna region, the third antenna portion forms a substantially rectangular second antenna region corresponding to the first antenna region on the second surface, an end of the third antenna portion is connected to an angle of the second antenna region, the other end of the third antenna portion extends so as to bisector the angle of the second antenna region, the second antenna region is substantially coincided coincident with the first antenna region, a remaining area of the second surface forms the grounding portion.

12. The wireless communication device of claim 8, wherein the substrate further comprises two parallel and opposite end portions and two parallel and opposite side portions, the end portions are perpendicularly connected to both ends of each side portion, the first antenna comprises a first antenna portion, a second antenna portion, and a feeding portion, an end of the first antenna portion is perpendicularly connected to one of the end portion, the other end of the first antenna portion extends along a direction parallel to the first side portions, an end of the second antenna portion is perpendicularly connected to one of the side portions, the other end of the second antenna portion extends along a direction parallel to the end portions and is perpendicularly connected to the first antenna portion to form an angle, an end of the feeding portion is connected to the angle between the first antenna portion and the second antenna portion, the other end of the feeding portion extends so as to bisector the angle.

13. The wireless communication device of claim 10, wherein an angle between the feeding portion and one of the first antenna portion and the second antenna portion is 45°.

14. The wireless communication device of claim 8, wherein the antenna structure is a global position system antenna and operates in an frequency band of about 1575 MHz-1620 MHz.
